(19) United States
(12) Patent Application Publication
(10) Pub. No.: US 2008/0183815 A1
(43) Pub. Date: Jul. 31, 2008

(54) PAGE NETWORKING SYSTEM AND METHOD

(76) Inventor: Assaf UNGER, Tel Aviv (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 11/668,490

(22) Filed: Jan. 30, 2007

(51) Int. Cl. G06F 15/16

(52) U.S. Cl. 709/204

(57) ABSTRACT

A method for enhancing the experience of a plurality of users who view the same resource using the Internet or an IPTV system. The method includes initially installing software by a portion of said plurality of users from a proprietary Web site. The method also includes creating, as a result of the initial installing step, a resource networking group and providing means thereby for the group members to communicate with each other as a community.

### FIELD OF THE INVENTION

The present invention relates to a system and a method for a resource networking system, and more particularly to a system and a method, which has a software component that allows communication activity between users who look at the same resource.

### BACKGROUND OF THE INVENTION

Today, the user of the Internet generally operates in an isolated fashion. The user generally browses by himself. It is known in the art that it is advantageous to take the individual user and place him in a group. One example of such a group is offered by ICQ™ instant messaging, wherein Internet users communicate with their friends and associates, according to their own preferences. However, users may have interests, and this fact may be valuable to both users and advertisers, based on those who are viewing the same resource.

US Pat. Appln. No. 20060026233, by Tenembaum, et al, Enabling Communication Between Users Surfing the Same Web Page, discloses a Web page, which is labeled as YACHNEE™ technology. YACHNEE™ is enabled by providing an icon on the page, which allows actuation upon being clicked. The user is then able to design a character to represent him on the screen. He also sees characters on screen representing other users, which characters have been designed by the users.

A user may move his character all over the screen by dragging it with his mouse and may rotate it towards or away from other characters. The characters may speak to each other, either through a voice communication or typing, in which case the text appears in a bubble (cartoon fashion). A user may change the appearance of a character to reflect an emotion (e.g. anger) and he may invite other characters to a private chatroom.

When a user leaves the Web page, the corresponding character disappears from all other users' screens. Communication among users viewing the same Web page is facilitated without the need for any program or plug-in other than what is standard in a Web browser. Additionally, such features as the automatic generation and de-activation of chat-rooms are possible, which in previous applications are pre-defined and independent of the presence of users.

YACHNEE™ indicates that the chatroom might become full. This is a problem because people on the same page might not be in the same room and would not be able to talk with each other.

YACHNEE™ indicates that there is no need for installation and that the client is served by using a flash client. This means they have 2 options for providing their service:

First option: To reprocess or stream the page through their Webpage and add their flash client;

Second option: To contact each Web owner and get his approval to add a flash content to their Webpage.

The first option presents several problems:

A) While re-streaming/reprocessing the page they create a heavy workload that will cause scalability problems and this could be the reason they limit the number of users per chatroom. But, in addition they will have many more scalability issues that will not allow them to support a large number of users overall;

B) The YACHNEE™ system occupies the side of the page area and limits the usable area of the page;

C) YACHNEE™ modifies the page content, which might lead them to legal issues;

D) YACHNEE™ copies the page data, which raises legal issues regarding copyright protection;

E) YACHNEE™ will not work on many types of pages, including dynamic pages and secure pages; and

F) The URL will need to be manipulated to allow the software to start.

In the second option, the system will not be available to all pages but only to pages that have cooperation with the Webpage owner. The Webpage owner will have full access to the code which might lead to control over certain data that is passed. Also, this might raise liability and legal issues affecting the site owner.

YACHNEE™ created an option for the user interface to allow the user to create icons which will also cover areas on the screen, and which can only be “dragged” inside the screen area.

Gabbly™ is an online service that is similar to YACHNEE™, as described above. Gabbly™ does not need any installation. Each page is re-streamed, thus avoiding the need for cooperation with the Web site owner. Gabbly™ can barely support the low number of users they have at the moment. The re-streaming causes them to crash if one attempts to access many large pages. They cannot work on dynamic pages because re-streaming has many limitations. Gabbly™ does not work on secure pages. Because Gabbly™ needs to re-stream the page through their domain, system integration for the surfing activity is broken each time a user surfs to a new page. The user needs to manipulate the URL from its actual address to the Gabbly™ domain address.

Gabbly™ also has a feedback option as part of the chat system, which remembers the last messages even though the user had left the chatroom. Gabbly™ only supports text messages and has no option other than that. There is no option to transfer files between users nor is there an option for an audio or video chat. Gabbly does not support private messaging between users and it does not allow a user to invite other users to other chatrooms. There is an option to select a name in Gabbly™, and to preserve user anonymity.

Pickpe™ is software on the Internet that operates per Website, but not for each page. Pickpe™ does not allow the user to chat per page and therefore does not allow the user to communicate with other users on the same very specific topic. Webpage sites have many topics. So, for example, if someone will enter the Yahoo™ Homepage, he will meet 1 million users or more, and each one may be interested in a different topic. Thus, Pickpe™ will not be able to support such a huge number of users per chatroom. The Pickpe™ software currently does not work, and they have many problems in their architecture design.

Therefore, it would be desirable to have a seamless, user-friendly communication center environment for viewing of the same resource.

### SUMMARY OF THE INVENTION

Accordingly, it is a principal object of the present invention to provide a resource networking system that will provide a seamless, user-friendly network and communication environment for viewing of the same resource.

A resource is defined as a network-data-object or service that can be identified, including a Web page, an electronic document, a pictorial image, a document image, an IPTV content module, etc.

It is another principal object of the present invention to provide a page networking system that will be available in every page in its current URL address, and the user will not need to manipulate that address.

It is still another principal object of the present invention to provide a white board as a linked feedback system for every resource, that allows a wide range of options, including the saving of messages and media segments, as well as the option to rate each feedback.

It is further principal object of the present invention to allow searches relevant to the feedback community.

It is one other principal object of the present invention for the whiteboard to be part of the World Wide Web, and to provide a search capability through all available search engines, without having to use the software of the present invention.

A method is disclosed for enhancing the experience of a plurality of users who view the same resource. The method includes initially installing software by a portion of said plurality of users from a proprietary Web site. The method also includes creating, as a result of the initial installing step, a page networking group and providing means thereby for the group members to communicate with each other as a community.

Another method is disclosed for enhancing the experience of a plurality of users who are viewing the same resource. The method includes also initially installing software by at least one Web site from a proprietary Web site. The method also includes creating, as a result of the initial installing step, a page networking group and providing means thereby for the group members to communicate with each other as a community. This will allow any viewer who accesses this resource to use any feature of the system with no installation. The resource owner will have a back office system enabling him to see a list of current viewers and communicate with any of them explicitly or implicitly, as well as having administrative rights over some features of the system. For example, the owner may have a unique symbol on the chat feature list of users on his resource, and may have an administrative option over whiteboards correspondences.

The present invention enables the user to initially install software, which will enable him to communicate with other users who are looking at the same resource and who also have the software installed. Each such user can chat with the other such users, send them files and communicate with them in many ways. If the users are on that resource at the same time, the chat situation is created. If users discover each other through that resource and are not there at the same time, they can leave messages and/or media segments on a whiteboard. The presentation of the whiteboard can be achieved in several ways, including on the sidebar, split page or a separate page, as well as an RSS option.

Resource description framework Site Summary (RSS), is a method of describing news, Weblogs (“blogs”) or other Web content that is available for “feeding” from an online publisher to Web users.

The whiteboard is exposed to the entire Internet community and no installation is needed to view the whiteboards. The whiteboard is a way of presenting messages and media segments on a page which is attached to the resource. A shared-folder is another way of presenting the messages and media segments that appear on the whiteboard, as in the Windows file system representation.

The system allows tracking of comments by user or topic, for example, throughout the entire Internet system. The classification of the topics can also be presented as highly rated vs. lower rated topics, and therefore the comments can be filtered in several ways: by user, by topic, by date or by rating, etc., and the tracking can be done from the chat feature area. This is significant, because while the chat is occurring, one can do research on the person with whom one is chatting, finding out about any comments left on the system on any Internet page.

From the chat area the user will see an indication coming from the whiteboard area of various levels of ratings and numbers of comments for each user listed, as well as his status, e.g., present or absent. A user can also be invited to the chat from a specific whiteboard comment, according to his status in the chat area. Statuses of the chat area are also seen on the whiteboard. Thus, a user's status can be “present” or “absent.” Since the user can choose to use an alias, another user will not be able to see his real details nor will they be able to see his permanent messages, so this can also be reflected in his status.

The whiteboard creates a place for the user to create content and place it in front of all the other users, which leads to an expansion of the communication generated by the corresponding resource. This includes management of the comments that are left by individual users, the ability to track the comments and ultimately integrate the knowledge that each of the users is contributing towards that resource content.

The system enables the users to rate the comments that are being produced and recorded, and these comments are given priority exposure in the page. Thus, highly-rated comments “bubble-up” towards the top of the scrollable list. Each comment can be given a “thumbs up” or a “thumbs down.”

Alternatively, a resource for example, a Web browser, can download, or otherwise receive the software, and then the chat and whiteboard adjuncts are available to all visitors to any page of the Web site or to any resource.

The resource networking system of the present invention has a software component, which allows communication between users who are looking at the same resource such as a Web page at the same time. They can communicate in a chatroom type of arrangement, where they can communicate using audio, video, file transfer, or private messages, etc. The present invention includes placement of an icon on a resource, such as Internet Explorer™, IPTV or mobile device, etc., that shows the number of users viewing the page and an icon that shows the number of items in the whiteboard.

The invention also includes a graphic user interface (GUI), which includes a sidebar, for example, which appears on the screen and includes a list of those users who are currently looking at that same resource at the same time. This list may be categorized by country, by alphabet, etc. Thus, there are various ways to sort the list so that the user can decide with whom to communicate in real time. Users can save the addresses of other users to a “buddy” list and invite them later to a resource communication chat, a private chat, an audio/video conference chat, a Webpage or the Webpage whiteboard. They can also unobtrusively access the web cam and/or audio microphone of multiple users from the buddy list and/or user list.

A user can preserve his privacy. The user can choose to use a nickname so that another user will not be able to see his real details nor will they be able to see his permanent messages.

In an exemplary embodiment, the sidebar opens when the user clicks on the icon in the browser that indicates the number of users viewing the Webpage or resource. The whiteboard is an html dynamic Webpage that opens after once clicking on the second browser icon that shows the number of items in the whiteboard. This page will be accessible as part of the World Wide Web. Some of the features of the page will be limited to users of the proprietary software.

The system architecture includes a set of servers, which support a large number of chat rooms, and the users in the room, besides oneself, are the user's neighbors. The system of the present invention is a distributed computing system, which has multiple instances of the same application running on multiple machines. The system also includes gateway servers, which hold the connection to the client. In order to be a subscriber to the service, the user has to install a particular software application. The user then becomes a resource network user and can use the system. The system also provides a resource network whiteboard for placement of messages and media segments allowing communication between the different users, or for leaving permanent messages or media segments on every resource such as a Web page.

In addition to application of the system in the browsing environment, the system can be adapted to use with IPTV enabling the user to connect to the resource network system, where the resource is now the TV show or channel.

Another aspect of the system is segmented advertising. Today the advertising that is sent on the Internet or TV is related words in a search engine or a Webpage, and the choice of where to advertise is according to the page content, and the ability to advertise is by contacting the Web page owner or a search engine owner to place one's advertisement on a particular Web page or search result.

The inventive system allows the choice of where to advertise to be made according to the resource, without contacting the resource owner. Instead, an advertisement is sent to a central Web advertising engine, and the advertisement will appear on the sidebar where the group of concurrent resource users has been established. This is also possible for the IPTV environment, as well as the whiteboard.

In the software of the present invention there will not be a limitation of scale, and every user that connects to the same resource room will be able to talk to every user that is viewing that resource.

The software will not block the area of the resource. The software will be available to all resources such as Web pages and IPTV channels and shows, with no need to cooperate with the resource owner and with no need to re-stream the resource content or data, for example, to the domain of the present invention. The user communication will be free from resource owner administration. There need not be any URL or channel manipulation

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which;

FIG. 1 is a screenshot of a typical Web page with the top toolbar and sidebar of the present invention shown on the left;

FIG. 2 is a schematic block diagram of the network architecture, constructed in accordance with the principles of the present invention;

FIG. 3 is a flow chart of method of the operation, performed in accordance with the principles of the present invention;

FIG. 4 is a screenshot of a preferred embodiment of a typical Web page with the sidebar of the present invention shown on the left; and

FIG. 5 is a screenshot of a preferred embodiment of a typical Web page with the sidebar of the present invention shown on the left.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

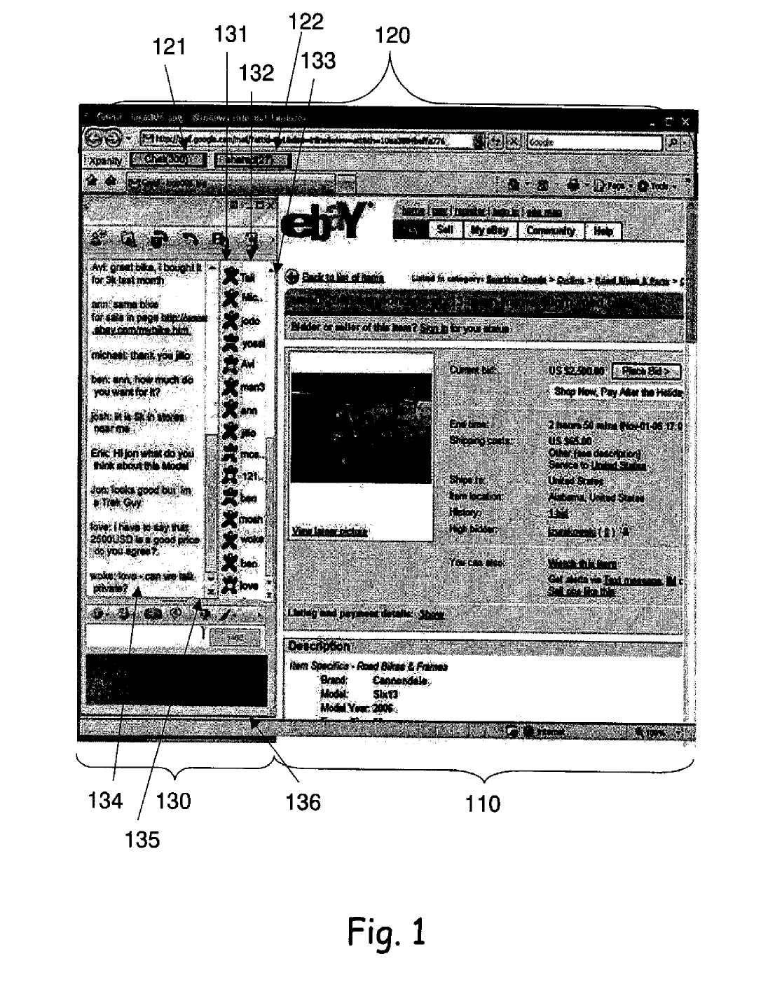

Reference is now made to FIG. 1, a screenshot of a typical Web page 110 with an exemplary top toolbar 120 and sidebar 130 of the present invention shown on the left. Top toolbar 120 shows the number of people connected in a chat session 121 for current Web page 110 and the number of shared files 122. Sidebar 130 shows the avatars 131 and nicknames 132 of the current participants with the avatar/nickname scroll mechanisms 133 and the comments 134 of the current participants with a comments scroll mechanism 135. A banner ad position 136 is also shown.

For advertising purposes, the segmentation of the chat room is to a page, where the ad is not on the page, but on the sidebar banner, for example. Thus, the advertiser can reach pages that do not directly allow advertising.

Existing banner ads are related to and attached to specific Web pages. With the present invention the advertiser can specify the amount of time, for example, that a banner ad of specific space will follow a user. The ad follows the user for that specific amount of time across any number of subsequent Web page transitions by each user. If an advertiser feels that his ad requires a minimum amount of time to be “digested,” he may specify the duration of “following time” for each user, accordingly. The ad becomes “attached” to each user, similarly to the duration feature of a 30 second or one minute ad, for example, on standard television.

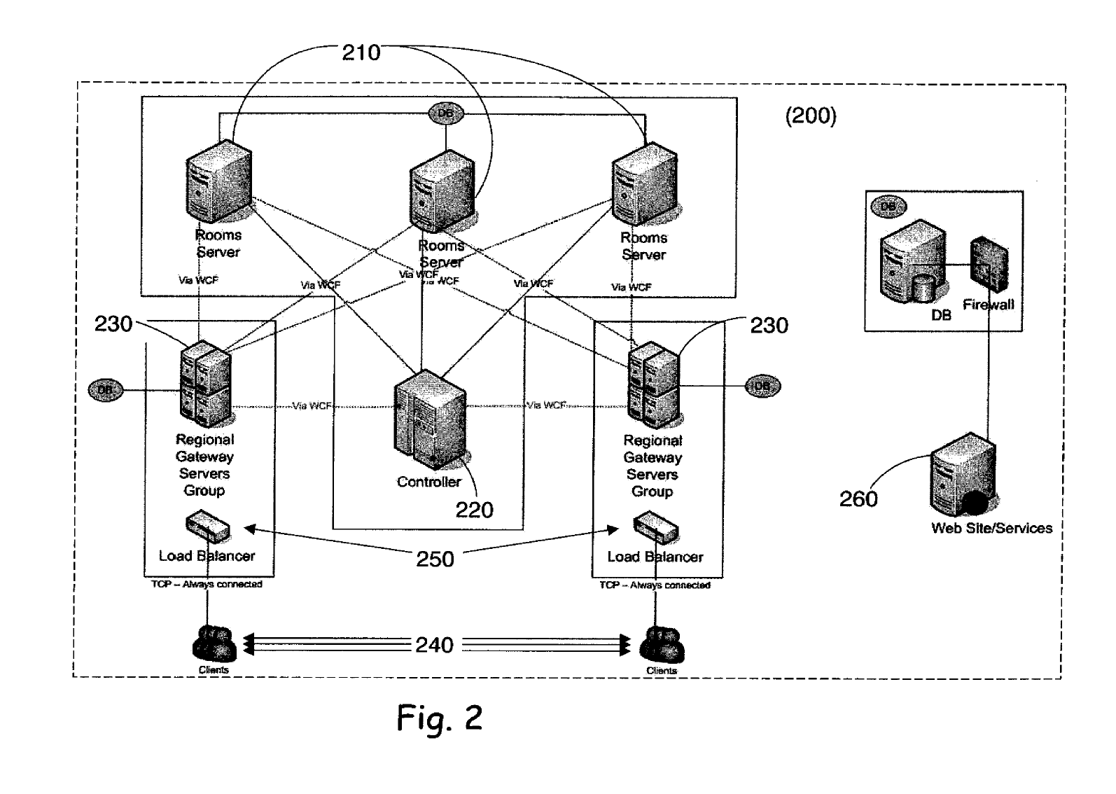

FIG. 2 is a schematic block diagram of an exemplary system network architecture 200, constructed in accordance with the principles of the present invention. System network architecture 200 includes a set of chatroom servers 210 under a single controller 220, which in turn can support a large number of chat rooms. The users in the room, besides oneself, are the user's neighbors. The system of the present invention is a distributed computing system, which has different instances of the same application running on multiple machines, according to Windows Communication Foundation™ (WCF) and.net™ technology. WCF is Microsoft's programming model for using managed code to build unified Web services and other distributed systems that can talk to each other.

The system also includes regional gateway servers 230 or farm servers, which hold the connections to the clients 240, under application of load balancers 250. In order to be a subscriber to the service, the user has to install a particular software application. The user then becomes a page network user, and can use the system, and the system also provides a page network whiteboard for placement of messages or media segments allowing communication between the different users, or for leaving permanent messages or media segments on the Web page or other resource.

Web site/Services 260 is a multi-server usenet client that works as a local usenet proxy. Web site/Services 260 automatically downloads all message bodies.

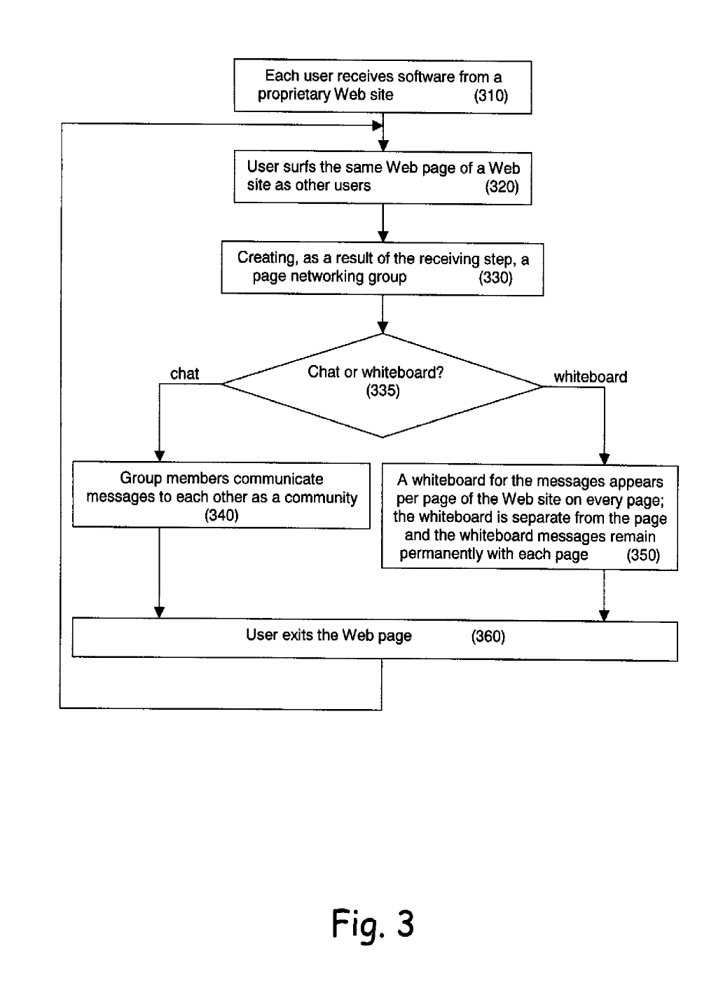

FIG. 3 is a flow chart of an exemplary method of operation, performed in accordance with the principles of the present invention. Each user, in order to participate in the page networking system of the present invention, has received software from a proprietary Web site 310. At any given time the user may surf the same Web page of a Web site as other users 320. As a result of the receiving step a page networking group is created, wherein the sidebar described in FIG. 1 appears for the receiving users 330.

The user chooses to be in chat mode or whiteboard mode 335. In chat mode the group members are then able to communicate messages, files and media segments with each other as members of a community 340. An exemplary pair of buttons on the sidebar allows the user to toggle between: chat mode, for users currently present; and whiteboard mode, for leaving permanent comments.

In whiteboard mode the whiteboard appears per page of the Web site on every page. The whiteboard is separate from the page and the whiteboard messages remain permanently with each page 350. The whiteboard pages are searchable on the Web. The user at some point exits the Web page 360. When the user enters another Web page, or possibly the same page, the process begins again 320.

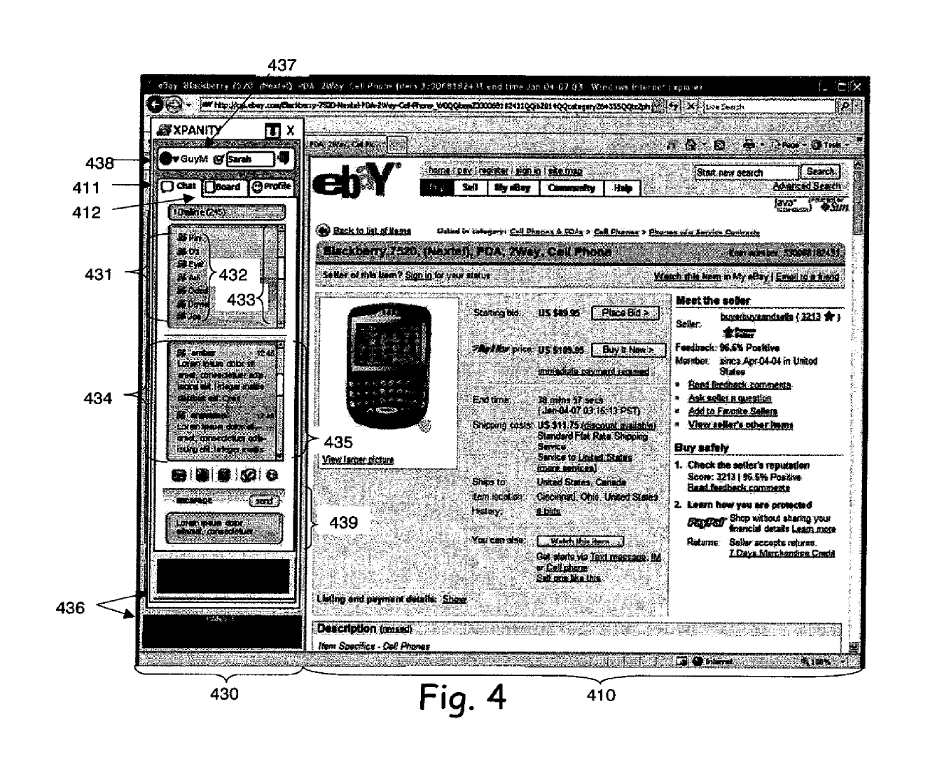

FIG. 4 is a screenshot of a preferred embodiment of a typical Web page 410 with the sidebar 430 of the present invention shown on the left. Sidebar 430 is in chat mode 411, as opposed to whiteboard mode 412. Sidebar 430 shows the avatars 431 and nicknames 432 of the current participants with the avatar/nickname scroll mechanisms 433 and the comments 434 of the current participants with a comments scroll mechanism 435. A send button and window 439 are provided to enter and send a new comment. Two banner ad positions 436 are also shown. The nickname of the current user 437 is shown with a scrollably chosen emoticon 438.

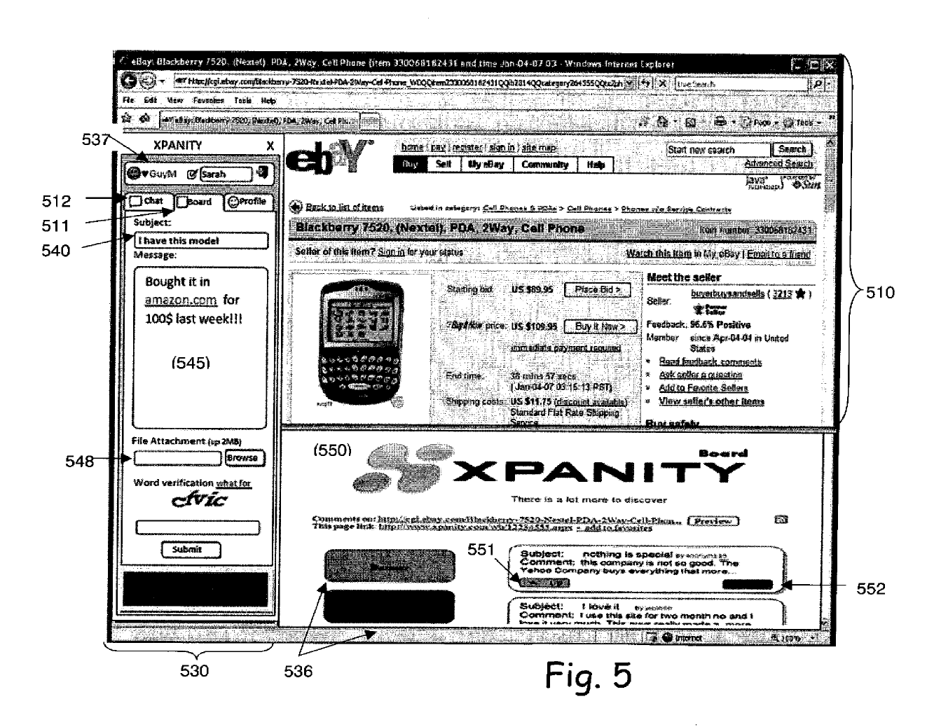

FIG. 5 is a screenshot of a preferred embodiment of a typical Web page 510 with the whiteboard mode sidebar 530 of the present invention shown on the left. Web page 510 is now in a split screen configuration, where the whiteboard 550 is at the bottom. Sidebar 530 is in whiteboard mode 511, as opposed to chat mode 512. Sidebar 530 shows a subject window 540 and the accompanying message 545 being left by the current user, who is identified by a nickname 537. There is also provision for sending files 548. Two additional banner ad positions 536 are shown. Whiteboard 550 shows recent messages with provision for rating “thumbs up” 551 and “thumbs down” 552 by the current user. Accordingly, the most highly rated comments are weighted to “bubble” upwards towards the top of the scrollable whiteboard list.

The present invention allows the creation of index services to the World Wide Web. In an exemplary embodiment the system shows an index of the most populated pages, and/or the most rated pages and/or the most highly rated pages and/or the pages with the most comments and other such real life criteria. The indices of the present invention allow the user to find a Website according to such real life criteria. The indices are available from the received and installed software or from the Web site of the present invention. In the prior art a user is limited to either a Web search for a topic or the use of bios indices of certain Web owners.

The users themselves will have a rating system depending on their participation within the system, which will be shown with a symbol as part of their nickname in the communication system and whiteboard.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A method for enhancing the experience of a plurality of users who view the same resource comprising at least one of a Web site and an IPTV system, said method comprising:
initially installing software on a user-operated device by a portion of said plurality of users from a proprietary Web site;
creating, as a result of the initial installing step, a resource networking group; and
providing means for members of said group to conduct communication activity with each other as a community.

2. The method of claim 1, wherein the viewing of a resource is in the form of surfing a Web page and the communication activity occurs seamlessly to the plurality of users.

3. The method of claim 1, wherein the communication activity is in the form of one of: a chat room; an audio conference; and a video conference a passive multiple webcam.

4. The method of claim 1, wherein the communication activity is in the form of sending each other a private message.

5. The method of claim 1, wherein the communication activity is in the form of sending each other at least one of files and media segments.

6. The method of claim 1, wherein the communication activity is in the form of tracking user's messages.

7. The method of claim 1, wherein the communication activity is in the form of adding a user to a permanent buddy list.

8. The method of claim 1, wherein the communication activity is in the form of inviting users from the buddy list to a Webpage.

9. The method of claim 1, wherein the communication activity is in the form of notification of a user's status comprising one of: present, absent and alias.

10. The method of claim 1, wherein a whiteboard for said communication activity appears on every resource or page of a resource, and wherein said whiteboard for every resource is one of separate from the resource and part of the resource.

11. The method of claim 10, wherein the whiteboard communication activity remains permanently.

12. The method of claim 10, wherein the communication activity can be rated.

13. The method of claim 12, wherein the user's communication activity is automatically rated.

14. The method of claim 1, further comprising the placing of an advertisement by an advertiser on at least one of said resources to be at least one of seen and heard by said plurality of users.

15. The method of claim 14, further comprising selecting by said advertiser of a plurality of resources on which to place said advertisement.

16. The method of claim 15, wherein said advertisement is separate from said resource.

17. The method of claim 15, wherein said selecting is selecting a region.

18. The method of claim 17, wherein said region is one of a geographical region and a URL region.

19. The method of claim 12, further comprising creating Webpage indexes for at least one of: said resources populated with the most communication activity; the most rated of said resources; and the most highly rated of said resources.

20. The method of claim 14, further comprising selecting by said advertiser of a time period over which said advertisement will follow each of said plurality of users, even after leaving said.

21. A distributed computing system for enhancing the experience of a plurality of users who are viewing the same resource of at least one of a Web site and an IPTV system, wherein said system allows the users to communicate messages to each other in a chat room environment, said system comprising:
at least one plurality of room servers; and
at least one controller to support a plurality of such said chat rooms.

22. The system of claim 21, wherein the surfing and the communication activity occur seamlessly.

23. The system of claim 21, wherein the communication activity is in the form of one of: a chat room; an audio conference; and a video conference.

24. The system of claim 21, wherein the communication activity is in the form of sending each other private messages.

25. The system of claim 21, wherein the communication activity is in the form of sending each other at least one of files and media segments.

26. The system of claim 21, wherein the communication activity is in the form of tracking user's messages.

27. The system of claim 21, wherein the communication activity is in the form of adding a user to a permanent buddy list.

28. The system of claim 21, wherein the communication activity is in the form of inviting users from the buddy list to a resource.

29. The system of claim 21, wherein the communication activity is in the form of notification of a user's status comprising one of: present, absent and alias.

30. The system of claim 21, wherein a whiteboard for said communication activity appears on every resource, and wherein said whiteboard for every resource is one of separate from the resource and part of the resource.

31. The system of claim 30, wherein the whiteboard communication activity remains permanently.

32. The system of claim 21, wherein the communication activity can be rated.

33. The system of claim 32, wherein the user's communication activity is automatically rated.

34. The system of claim 21, further comprising the placing of an advertisement by an advertiser on at least one of said resources to be at least one of seen and heard by said plurality of users.

35. The system of claim 34, wherein said advertiser selects a plurality of resources on which to place said advertisement.

36. The system of claim 35, wherein said advertisement is separate from said resource.

37. The system of claim 35, wherein said selecting is selecting a region.

38. The system of claim 37, wherein said region is a geographical region.

39. The system of claim 37, wherein said region is one of a URL and a geographical region.

40. The system of claim 34, wherein said advertiser selects a time period over which said advertisement will follow each of said plurality of users, even after leaving said resource.

41. A method for enhancing the experience of a plurality of users who are viewing the same resource comprising a Webpage of at least one of a Website and an IPTV system comprising:
initially installing software on a user-operated device by at least one Website, said software being provided from a proprietary Website;
creating, as a result of the initial installing step, a resource networking group; and
providing means for members of said group to conduct communication activity with each other as a community.
